(19) United States
(12) Patent Application Publication
(10) Pub. No.: US 2026/0109351 A1
(43) Pub. Date: Apr. 23, 2026

(54) VEHICULAR DRIVING ASSIST SYSTEM WITH TRAFFIC FLOW DETERMINATION

(71) Applicant: Magna Electronics Inc., Auburn Hills, MI (US)

(72) Inventors: Arihant Jain, Auburn Hills, MI (US); Arpit Awathe, Rochester Hills, MI (US); Tejas Murlidhar Varunjikar, Troy, MI (US); Atharva Chandorkar, Ann Arbor, MI (US)

(21) Appl. No.: 19/361,230

(22) Filed: Oct. 17, 2025

Related U.S. Application Data
(60) Provisional application No. 63/710,158, filed on Oct. 22, 2024.

(51) Int. Cl. B60W 30/14; B60W 10/20; B60W 30/18

(52) U.S. Cl. CPC B60W 30/143; B60W 10/20; B60W 30/18163; B60W 2420/403; B60W 2420/408; B60W 2552/10; B60W 2554/4041; B60W 2554/4042; B60W 2554/4046; B60W 2554/408; B60W 2555/60; B60W 2710/20; B60W 2720/106

(57) ABSTRACT

A vehicular driving assist system includes a sensor disposed at a vehicle that captures sensor data. The system determines a leading vehicle traveling ahead of the equipped vehicle and in the same traffic lane as the equipped vehicle. The system determines a plurality of velocity measurements of the leading vehicle and determines, based on the plurality of velocity measurements, (i) an acceleration pattern of the leading vehicle and (ii) an average velocity of the leading vehicle. The system, responsive to determining the acceleration pattern of the leading vehicle and the average velocity of the leading vehicle, determines a traffic flow condition of the traffic lane.

### CROSS REFERENCE TO RELATED APPLICATION

The present application claims the filing benefits of U.S. provisional application Ser. No. 63/710, 158, filed Oct. 22, 2024, which is hereby incorporated herein by reference in its entirety.

### FIELD OF THE INVENTION

The present invention relates generally to a vehicle sensing system for a vehicle and, more particularly, to a vehicle vision system that utilizes one or more cameras or other sensors at a vehicle.

### BACKGROUND OF THE INVENTION

Use of imaging sensors in vehicle imaging systems is common and known.

Examples of such known systems are described in U.S. Pat. Nos. 5,949,331; 5,670,935 and/or 5,550,677, which are hereby incorporated herein by reference in their entireties.

### SUMMARY OF THE INVENTION

A vehicular driving assist system includes a sensor disposed at a vehicle equipped with the vehicular driving assist system. The sensor senses at least forward of the equipped vehicle, and the sensor is operable to capture sensor data. The system includes an electronic control unit (ECU) with electronic circuitry and associated software. Sensor data captured by the sensor is transferred to the ECU. The electronic circuitry of the ECU includes a data processor, and the data processor is operable to process sensor data captured by the sensor and transferred to the ECU. The vehicular driving assist system, while the equipped vehicle travels along a traffic lane of a road, and via processing at the ECU of captured sensor data, determines a leading vehicle ahead of the equipped vehicle and traveling in the same traffic lane as the equipped vehicle. The vehicular driving assist system, at least in part via processing at the ECU of captured sensor data, determines a plurality of velocity measurements of the determined leading vehicle. The vehicular driving assist system, based on the plurality of velocity measurements, (i) determines an acceleration pattern of the determined leading vehicle and (ii) determines an average forward velocity of the determined leading vehicle. The vehicular driving assist system, responsive to determining the acceleration pattern of the determined leading vehicle and the average forward velocity of the determined leading vehicle, determines a traffic flow condition of the traffic lane ahead of the equipped vehicle.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a sensing system that incorporates cameras and radar sensors;

FIG. 2 is a diagram of a traffic congestion determination (TCD) module integrated with an advanced driver assistance system of the equipped vehicle;

FIG. 3 is a diagram of the TCD module and submodules of the TCD module;

FIG. 4 is a graph of a first example acceleration of a target object as determined by the TCD module;

FIG. 5 is a diagram of a velocity buffer of the TCD module;

FIG. 6 is a graph of a first example average non-zero velocity of a target object as determined by the TCD module;

FIG. 7 is a diagram of a selection block submodule of the TCD module;

FIG. 8 is a diagram of a velocity buffer submodule of the TCD module;

FIG. 9 is a diagram of a lane switch submodule of the TCD module;

FIG. 10 is a diagram of an example velocity buffer reassignment based on a lane change performed by the equipped vehicle;

FIG. 11 is a graph of a second example average non-zero velocity of a target object determined by the TCD module, including a threshold velocity value, an upper limit threshold, and a lower limit threshold determined by the TCD module; and

FIG. 12 is a graph of a second example acceleration of a target object as determined by the TCD module.

### DESCRIPTION OF THE PREFERRED EMBODIMENTS

A vehicle sensing system and/or driver or driving assist system and/or object detection system and/or alert system operates to capture images or other sensor data exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide a display, such as a rearview display or a top down or bird's eye or surround view display or the like.

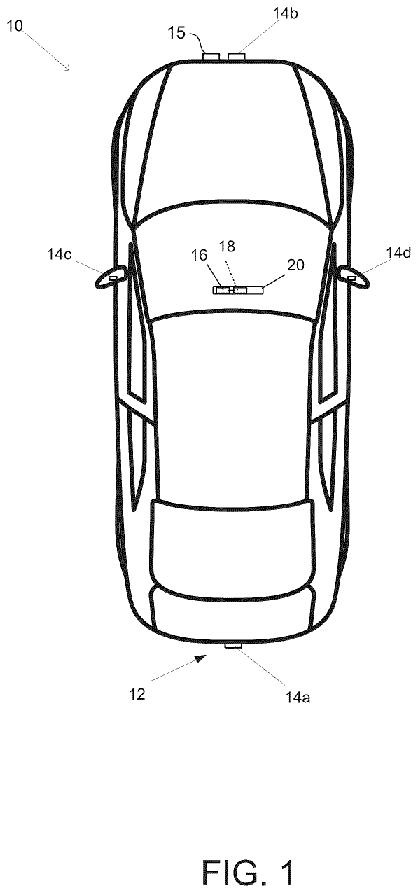

Referring now to the drawings and the illustrative embodiments depicted therein, a vehicle 10 includes an imaging system or sensing system 12 that includes at least one exterior viewing imaging sensor or camera, such as a rear backup camera or rearward viewing imaging sensor or camera 14a (and the system may optionally include multiple exterior viewing imaging sensors or cameras, such as a forward viewing camera 14b at the front (or at the windshield) of the vehicle 10, and a sideward/rearward viewing camera 14c, 14d at respective sides of the vehicle 10), which captures images exterior of the vehicle 10, with the camera having a lens for focusing images at or onto an imaging array or imaging plane or imager of the camera (FIG. 1). The system 12 may also include other sensors, such as one or more radar sensors 15, lidar sensors, ultrasonic sensors, etc. The radar sensor 15 includes a plurality of transmitters that transmit radio signals via a plurality of antennas. The radar sensor 15 also includes a plurality of receivers that receive radio signals via the plurality of antennas. The received radio signals are transmitted radio signals that are reflected from an object.

Optionally, the forward viewing camera 14b may be disposed at the windshield of the vehicle 10 and view through the windshield and forward of the vehicle 10, such as for a machine vision system (such as for traffic sign recognition, headlamp control, pedestrian detection, collision avoidance, lane marker detection and/or the like). The vision system 12 includes a control or electronic control unit (ECU) 18 having electronic circuitry and associated software, with the electronic circuitry including a data processor or image processor that is operable to process image data captured by the camera or cameras, whereby the ECU may detect or determine presence of objects or the like and/or the system provide displayed images at a display device 16 for viewing by the driver of the vehicle 10 (although shown in FIG. 1 as being part of or incorporated in or at an interior rearview mirror assembly 20 of the vehicle 10, the control and/or the display device may be disposed elsewhere at or in the vehicle 10). The data transfer or signal communication from the camera to the ECU may comprise any suitable data or communication link, such as a vehicle network bus or the like of the equipped vehicle 10 (i.e., the ego vehicle).

With the increased involvement of technology in the automotive industry, Advanced Driver Assistance Systems (ADAS) play a pivotal role in driver safety and comfort. Such systems can leverage data from various sensors, such as cameras and radars, to monitor the surrounding environment. The information obtained is utilized in multiple driver assistance features that support driving tasks. Detecting traffic congestion in both a host lane (i.e., a lane in which the vehicle equipped with the ADAS is traveling) and lanes adjacent to the host lane (i.e., the left lane and the right lane adjacent to the equipped vehicle 10) allows the equipped vehicle 10 to facilitate the detection of traffic congestion. These sensors, such as one or more cameras and/or radars, provide data about the equipped vehicle's surroundings, resulting in accurate recognition of a traffic flow pattern.

Due to improvements in ADAS features including Adaptive Cruise Control (ACC), Lane Centering Control (LCC), Lane Change Assist (LCA), etc., drivers increasingly rely on these features for daily commuting. Drivers now expect these features to perform in a manner akin to a human driver to improve the driving experience.

Existing ADAS features (e.g., ACC and LCA) can navigate common driving scenarios, but with their increased adoption, these features may have degraded performance in certain scenarios, such as during oscillatory traffic flow. In high-density traffic scenarios, a target vehicle (i.e., a vehicle proximate to the equipped vehicle 10, such as leading vehicle immediately in front of the equipped vehicle) may perform a periodic oscillatory movement (i.e., oscillatory traffic flow) by periodically increasing and decreasing speed. In response, the equipped vehicle's ACC feature may emulate the oscillatory movement. For example, when the target vehicle accelerates, the ACC may prompt a rapid acceleration of the equipped vehicle 10. Conversely, when the target vehicle stops, the ACC may trigger an intense deceleration of the equipped vehicle 10. Such acceleration and deceleration may result in the driver of the equipped vehicle 10 experiencing a jerking sensation, causing fatigue and discomfort.

Existing ADAS features may also have degraded performance in lane-specific traffic congestion. In scenarios of congested traffic flow, a particular lane of a roadway can be congested due to construction activity, a vehicle accident or breakdown, etc. Meanwhile, lanes adjacent to the congested lane may have comparatively less-dense traffic flow. When the equipped vehicle 10 is in the congested lane as opposed to one of the adjacent, less-congested lanes, a resulting increased commute time can cause the driver discomfort or frustration.

Implementations herein include a traffic congestion detection (TCD) module (i.e., traffic congestion module or traffic flow detection module) which may be integrated with ADAS features that control the equipped vehicle's longitudinal and lateral movements. By detecting traffic congestion, these features can adjust their control commands to emulate smooth and comfortable driving behavior. This results in enhanced comfort for both the driver and passengers of the equipped vehicle 10.

The TCD module may continuously monitor traffic flow surrounding the equipped vehicle 10, including other vehicles (i.e., objects, such as moving or non-moving vehicles) in the host and adjacent lanes, using sensor inputs and data. By analyzing data such as object information, lane information, and the state of the equipped vehicle 10, the TCD module determines characteristics of the traffic flow by tracking the velocities of surrounding objects for a period of time and evaluating the objects'acceleration (i.e., velocity gradient) and/or average non-zero (i.e., forward) velocities against a traffic speed limit or setspeed threshold. Once the TCD module identifies a traffic flow pattern, the analyzed data may be communicated to the ADAS features (e.g., ACC, lane-assist, etc.) to moderate acceleration, deceleration, and steering commands according to the ADAS's requirements. Additionally, the TCD module can suggest, maneuver, or perform smooth auto-lane change to an adjacent lane with less congested traffic flows, leading to reduced travel time and improved passenger comfort.

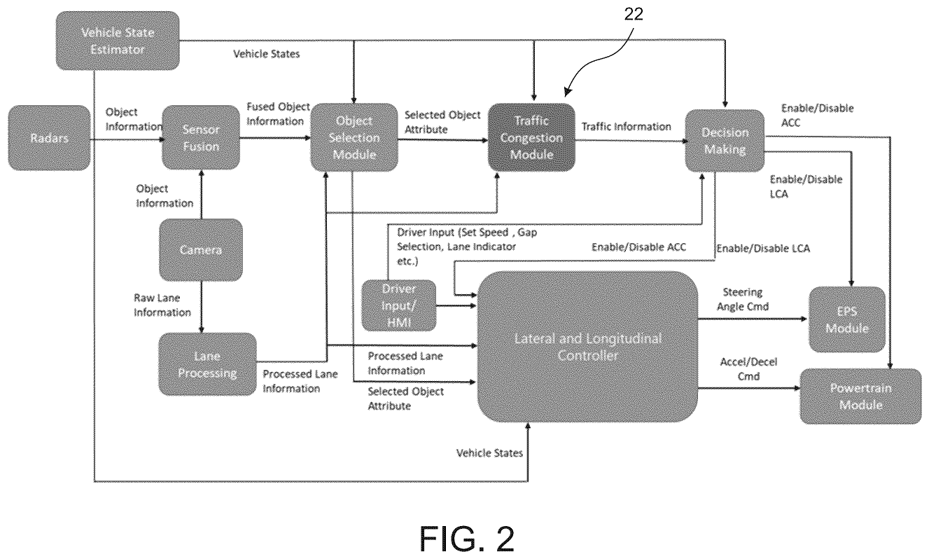

FIG. 2 illustrates a TCD module 22 integrated with the ADAS system of the equipped vehicle. A front camera module (FCM) includes camera hardware and software for sending raw (i.e., unprocessed) lane and object information regarding objects forward of and/or adjacent to the equipped vehicle, including lane coefficients, quality, relative position, velocity, acceleration, object type, etc. Radar sensors may include complete radar hardware and software, providing raw object information including object relative position, velocity, acceleration, object type, etc. A sensor fusion module uses the object information from the sensors of the equipped vehicle and combines the object information (e.g., by fusing image data captured by a camera and radar data captured by a radar sensor) to determine an accurate position of each sensed object along with various object attributes and/or object specific parameters including pose, velocity, acceleration, etc.

A target object selection module identifies valid objects (i.e., relevant objects or objects proximate to the vehicle) in accordance with the data determined by sensor fusion. The target object selection module provides selected object attributes (e.g., position, pose, acceleration, and/or velocity) regarding the identified valid objects to the TCD module 22 and the lateral motion control module and the longitudinal motion control module. A lane processing module processes the raw lane information provided by the FCM to determine accurate lane type, lane color, lane coefficients, and relevant lane information. A vehicle state estimator estimates states of the equipped vehicle, including vehicle speed, yaw rate, lateral acceleration, steering angle, etc., using current state information and external conditions that affect the state of the equipped vehicle, such as road gradient or road camber. Driver input and a Human Machine Interface (HMI) facilitate an exchange of information between the driver and hardware of the equipped vehicle to set or provide feedback regarding values such as a set speed of the equipped vehicle, gap selection (i.e., a selected desired gap or distance between the equipped vehicle and a target vehicle), driver disengagement, driver alerts, etc. A decision-making module may use vehicle states, raw lane information, processed lane information, sensor fusion data, traffic information from the TCD module 22, etc., to decide whether to enable or disable the ACC, LCC, LCA, and/or other ADAS features. A lateral trajectory generation module may determine a relevant path or trajectory for lateral movement of the equipped vehicle based on outputs of the decision-making module, driver input/HMI, and selected attribute information (e.g., position, velocity, acceleration, yaw rate, etc.) of the equipped vehicle or of one or more objects proximate to the equipped vehicle. A longitudinal trajectory generation module may determine a relevant path or trajectory for longitudinal movement of the equipped vehicle based on the outputs of the decision-making module, driver input/HMI, and selected attribute information of the equipped vehicle or one or more objects proximate to the equipped vehicle. In some examples, the lateral trajectory generation module and the longitudinal trajectory generation module may be combined into a single module that determines relevant path and trajectory for both lateral and longitudinal movement.

A lateral motion control module may generate steering commands for the equipped vehicle based on a desired vehicle trajectory and current vehicle states. Steering commands may be in terms of steering angle (i.e., steering angle at the front wheels of the equipped vehicle), steering wheel angle, or curvature of the trajectory of travel of the equipped vehicle (i.e., trajectory). A longitudinal motion control module generates acceleration/deceleration commands for the equipped vehicle based on the vehicle's planned longitudinal trajectory and current vehicle states. An electrical power steering (EPS) module includes hardware and software of the equipped vehicle's steering system. The EPS module may apply steering commands to enable lateral control of the equipped vehicle based on ADAS feature determinations. The EPS module may receive the steering command from the lateral motion control module and input from the decision-making module. A powertrain module is an actuation system for the equipped vehicle that determines throttle commands based on ADAS feature determinations, providing acceleration and deceleration for precise longitudinal control of the equipped vehicle. The powertrain module may include a hardware and software interface.

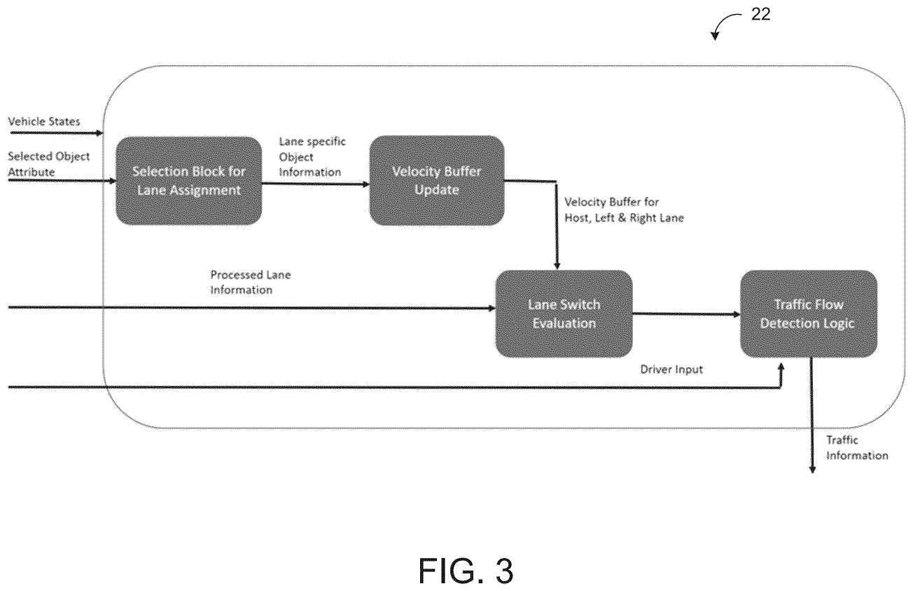

FIG. 3 illustrates an example embodiment of the TCD module 22 along with respective submodules. Here, a selection block submodule determines lane specific object information, grouping object information with a relevant lane based on selected object attributes, such as position of an object (e.g., a target object) relative to the equipped vehicle as determined by, e.g., sensor fusion. For example, the selection block submodule determines information pertaining to a relevant lane based on the available information obtained from the selected object attributes of valid objects. Selected object attributes may further include pose, velocity, and/or acceleration of the object. A velocity buffer submodule maintains a buffer of velocity history for the target object based on the lane specific object information determined by the selection block submodule. For example, the velocity buffer submodule may maintain a buffer of velocity history for target objects associated with each of the host lane, left lane, and right lane. A lane switch submodule maintains the lane-specific velocity history from the velocity buffer submodule when the equipped vehicle performs a lane change. For example, when the equipped vehicle performs a lane change, the lane switch submodule preserves the corresponding lane-specific velocity history based on the processed lane information available. A traffic flow detection logic submodule characterizes a traffic pattern occurring over a buffer period, thus providing traffic flow information integrated with other ADAS features. In some examples, the traffic flow detection logic submodule may characterize the traffic pattern based on driver input (e.g., acceleration, braking, steering inputs of the driver of the equipped vehicle) and lane-specific vehicle history preserved by the lane switch submodule.

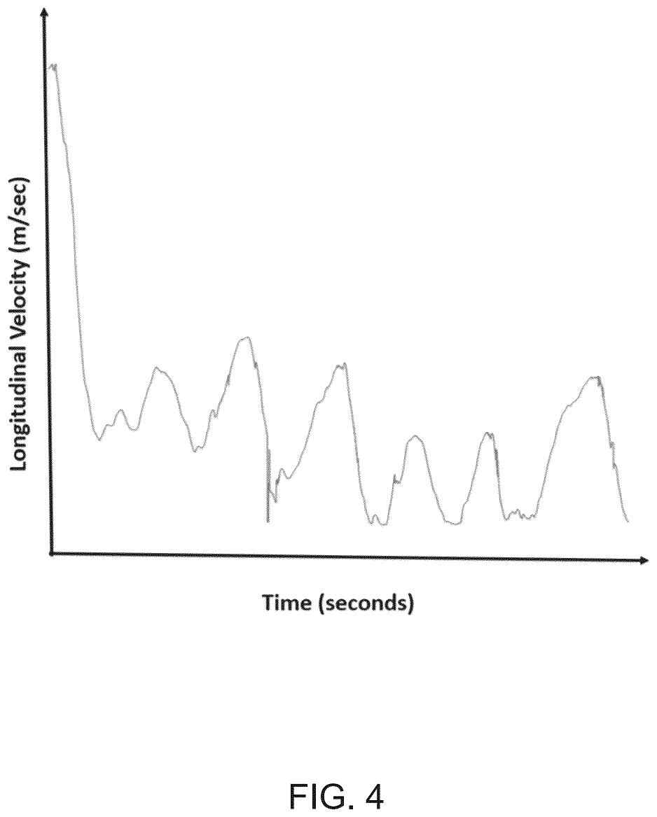

FIG. 4 illustrates an example acceleration with an oscillatory pattern that corresponds with an object in a high-density traffic flow scenario. The high-density traffic flow scenario is characterized by multiple changes in the sign of the acceleration of the object (i.e., alternating speeding up and slowing down). When an oscillatory pattern occurs repeatedly over a time duration (e.g., 1 oscillation in 5 seconds, 1 oscillation in 10 seconds, 3 oscillations in 10 seconds, 3 oscillations in 30 seconds, 5 oscillations in 30 seconds, 5 oscillations in 60 seconds, 10 oscillations in 3 minutes, etc.), the pattern may represent an apt characteristic of a traffic flow occurrence. A vehicle in a traffic flow scenario characterized by the oscillatory pattern will cyclically accelerate and decelerate over the time duration. Traffic flow is a prolonged phenomenon that cannot be distinguished instantaneously. Accordingly, a system that uses longitudinal velocity monitoring and evaluation to instantaneously detect traffic congestion can lead to false predictions of high-density traffic flow. In order to capture the recurring behavior of velocity patterns and acceleration changes, the system evaluates the history of the pattern to encapsulate randomized movements.

To accurately characterize these oscillatory velocity patterns, the TCD module includes a buffer that maintains a history of instantaneous longitudinal velocities of one or more target objects traveling in a current lane of the road along which the equipped vehicle is traveling and/or an adjacent lane to the current lane. The buffer repeatedly stores instances of velocity measurements of the target object as recorded by the sensors of the equipped vehicle. For example, the buffer may store “n” seconds of velocity data to represent the velocity pattern of the target object so that the TCD module can determine a traffic flow scenario from the stored velocity data, where “n” represents the number of seconds of data that the buffer can store. In other words, to determine the behavior of the target object in the traffic flow scenario, the buffer is designed to hold a sufficient amount of velocity data (e.g., at least five seconds, at least ten seconds, at least thirty seconds, etc.) to precisely represent the recurrent velocity pattern. The system may add a new or current instantaneous velocity value for each tracked object periodically (e.g., once a second) to the buffer.

Traffic congestion determination that analyzes the velocity of the equipped vehicle to determine traffic flow may result in processing delays for the system. Such processing delays may lead to slower recognition of traffic congestion which, if transmitted to ADAS features such as ACC and LCA, can cause suboptimal longitudinal and lateral control outputs and movements of the equipped vehicle. To avoid such suboptimal outputs and movements, the traffic congestion determination module maps velocity profiles of the target objects (i.e., target vehicles) based on target object information gathered by the sensors and information processing of the equipped vehicle. The traffic congestion determination module selects the target objects from the valid objects identified in the sensor fusion data based on the closest in-path vehicle (i.e., the closest target object to the equipped vehicle in the host lane) and the closest target objects in the lanes adjacent to the equipped vehicle (i.e., the lateral lanes).

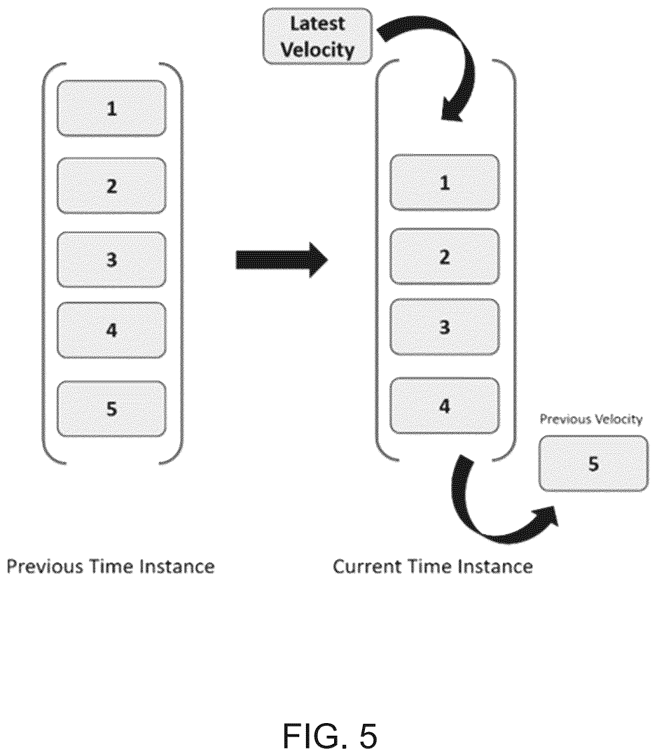

FIG. 5 illustrates an example velocity buffer of the TCD module. The TCD module updates the velocity buffer using a top-in-bottom-out (e.g., first-in-first-out) approach. The TCD module continuously updates the velocity buffer with valid longitudinal velocities of a target vehicle measured at fixed time durations (e.g., a time duration within the range of 1 tenth of a second to 1 second). After the velocity buffer is full, the traffic congestion determination module determines an acceleration and/or an average non-zero velocity for the target vehicle. The buffer may be a circular buffer, where, once full, the oldest data is overwritten by the newest data.

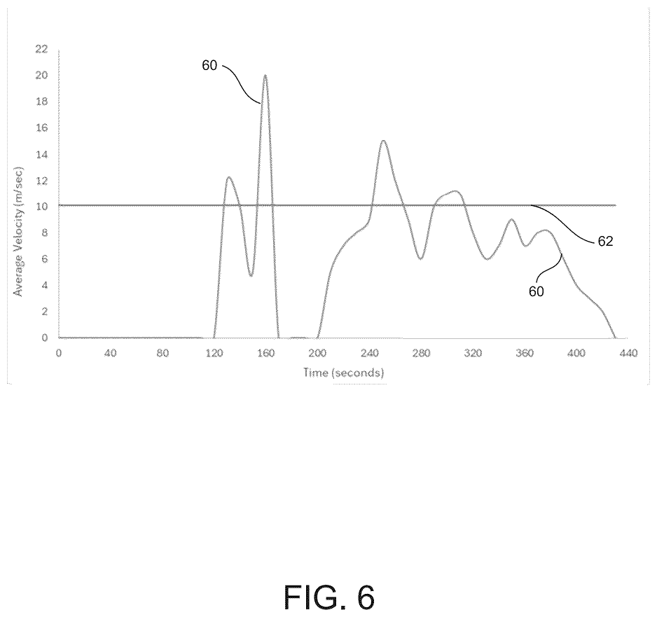

As shown in FIG. 6, in high-density traffic flow scenarios, the determined average non-zero velocity 60 of the target vehicle is lower than a threshold value 62 of either the traffic speed limit of the road along which the equipped vehicle is traveling or the set-speed of the equipped vehicle's ACC. The equipped vehicle may obtain the traffic speed limit via a traffic sign recognition module, which records the speed limit changes on the road along which the equipped vehicle is traveling using a sensor such as an FCM. When the average non-zero velocity 60 of the target vehicle is below the threshold value 62, the TCD module may determine a probability of high-density traffic flow.

The TCD module may determine an average velocity of the target vehicle based on velocity values stored in the velocity buffer when the velocity buffer includes a threshold amount of data. In some examples, the threshold is when the buffer is completely full. In other words, the TCD module may determine the average velocity when the velocity buffer contains “n” seconds of velocity data. If the ADAS does not identify a valid object for the time equivalent of the threshold, the TCD module may reset the velocity buffer. Once the ADAS has identified a target object, the velocity buffer may resume storing measured velocity data. Based on a velocity pattern and average non-zero velocity 60 of the target object, the TCD module may classify traffic flow scenarios of one or more of the host lane (i.e., the traffic lane the equipped vehicle is currently traveling along), the left adjacent lane, and the right adjacent lane.

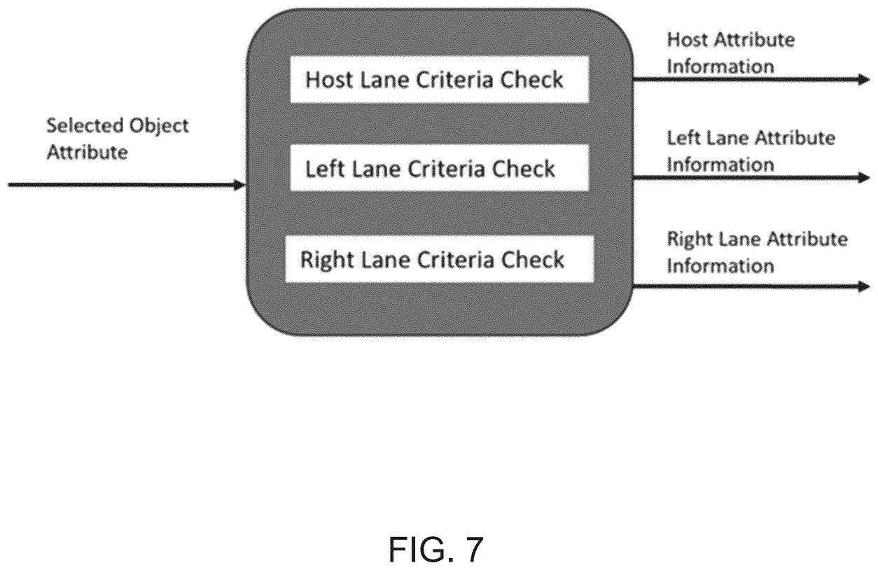

The TCD module identifies characteristic patterns of a high-density traffic flow scenario by analyzing the velocity pattern of a target object over a period of the velocity buffer. As shown in FIG. 7, when the TCD module receives selected object attribute information, the selection block submodule attributes objects of the selected object information according to lane assignment criteria. Accordingly, the selection block submodule determines attribute information for one or more of the host lane, the left lane, and the right lane (i.e., lane-specific information). For example, selected object information data may include longitudinal speed and object identity of a plurality of objects identified by the ADAS. The selection block submodule dynamically checks the lane assignments corresponding to the host lane and lateral lanes and determines longitudinal speed and vehicle identification for each lane. That is, the TCD module determines lane-specific information for each of the current lane and each adjacent lane that is based on information associated with the objects within those lanes, such as longitudinal speeds, lateral speeds, positions, etc.

After the selection block submodule determines lane-specific information, a velocity buffer may store instantaneous longitudinal velocities of the target objects. Because the velocity buffer has limited storage capacity, the buffer does not store data for every sample time and fully capture a prolonged structure of a traffic pattern. The velocity buffer includes a timer block designed to hold an incoming velocity measurement measured at “T” seconds. The timer block may update the velocity buffer for every “T” second until the length of the buffered data is “nT,” where “n” represents the number of instantaneous longitudinal velocities recorded in the velocity buffer. This may provide the TCD module with sufficient velocity data history to detect characteristic patterns in traffic flow.

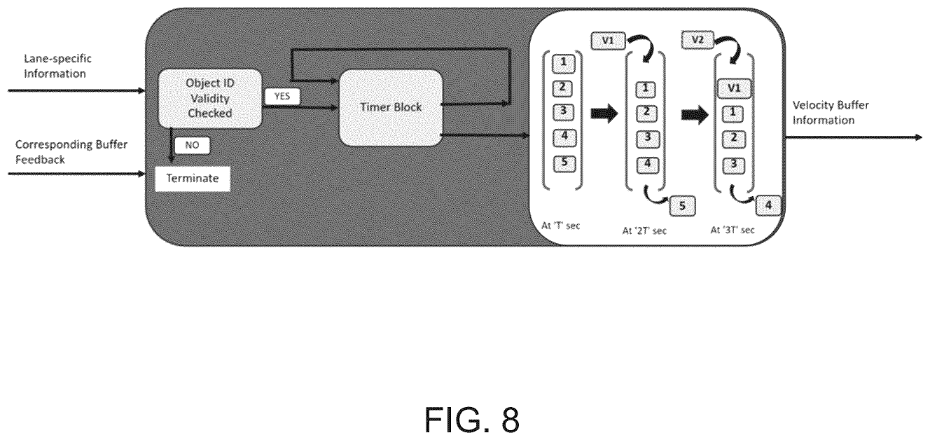

FIG. 8 illustrates an exemplary velocity buffer submodule. Here, when the velocity buffer receives the lane-specific information containing identities of valid objects, the velocity buffer submodule passes velocity information of target objects in the timer block. The timer block then adds the velocity information to the buffer every “T”seconds. Buffer feedback is added as a unit delay input to the velocity buffer submodule to reconfigure the history of the previous velocities in the respective buffer at every sample time. In some examples, the TCD module may include a velocity buffer submodule for each of the host lane, left lane, and right lane. In other examples, the velocity buffer submodule may maintain a separate velocity buffer for each of the host lane, left lane, and right lane.

After obtaining velocity buffer information corresponding to the host lane, left lane, and right lane, the TCD module may reassign the lane designations when the equipped vehicle performs a lane change to an adjacent lane. In response to the lane change, the lane switch submodule will reassign the velocity buffers of the previous lane assignments to new lane assignments. Accordingly, the lane switch submodule preserves the velocity data history of the target objects, avoiding the need to reset the buffer data. In other words, the buffer reassignment of the lane switch submodule may avoid requiring the TCD module to wait for a time the length of the buffer to determine the traffic flow pattern.

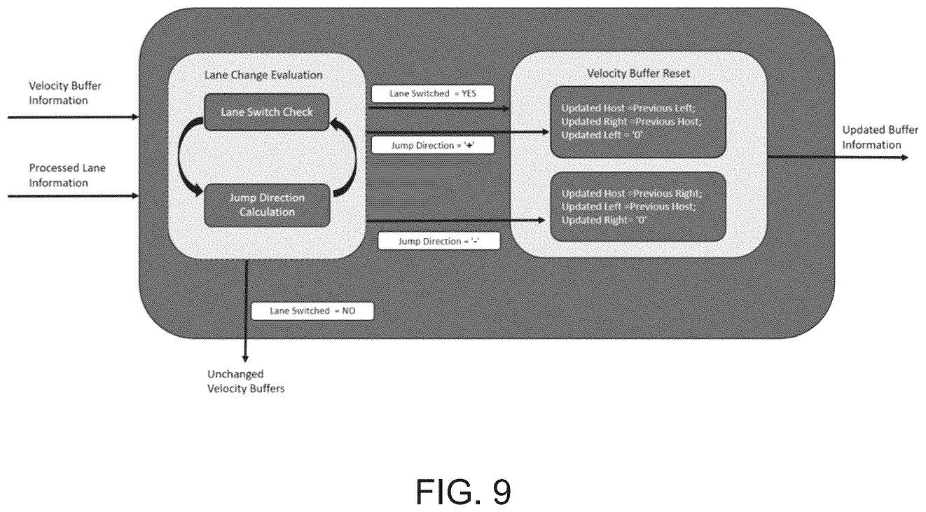

FIG. 9 illustrates the lane switch submodule. The lane switch submodule uses processed lane information obtained from an “n”-degree polynomial expression to determine whether the equipped vehicle has performed a lane-change maneuver (i.e., a lane change). In the event of a lane change, the direction of the lane change (i.e., the lane jump direction) is used to determine reassignments of the velocity buffers. In other words, if a lane change maneuver has occurred, the lane-change submodule will reassign the velocity buffers of the host lane, left lane, and right lane to reflect the lane change. Accordingly, the lane switch submodule performs an evaluation to determine velocity buffer reassignment, where the submodule checks certain conditions before implementing the buffer reassignment.

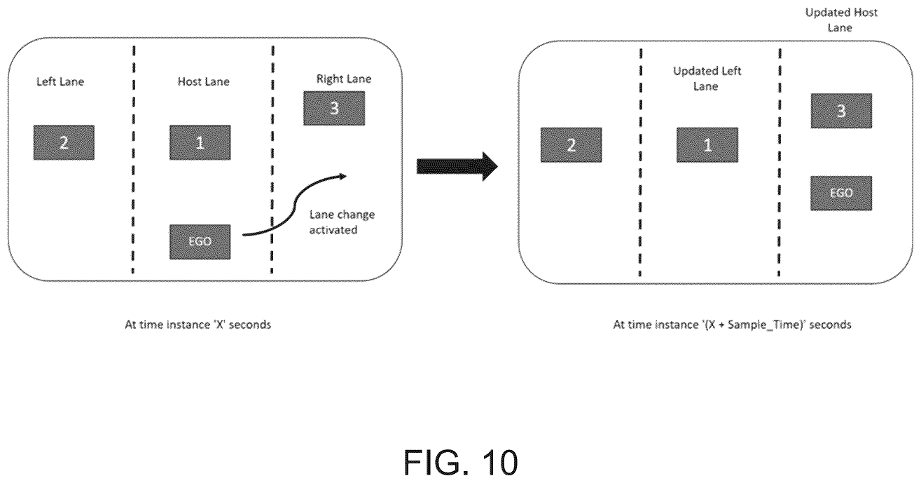

For example, as illustrated in FIG. 10, the equipped vehicle may perform a lane change to the adjacent lane right of the host lane (i.e., the right lane). At time “X” seconds, the velocity buffer for the target vehicle of the host lane is labeled “1,” the velocity buffer for the target vehicle of the left lane is labeled “2,” and the velocity buffer of the right lane is labeled “3.” When the equipped vehicle switches lanes, the processed lane information indicates that the direction is negative, indicating a right lane change. Alternatively, if the equipped vehicle performed a lane change from the host lane to the left lane, the processed lane information would indicate that the direction is positive, indicating a left lane change. At time “X +Sample_Time,” the lane switch submodule may reassign velocity buffer “3” as the host lane buffer and reassign velocity buffer “1” as the left lane buffer. The lane switch submodule reassigns velocity buffer “2” as the right lane buffer and resets velocity buffer “2” (e.g., fills the velocity buffer with zeros) until the target object selection module identifies a new valid object in the new right lane.

The traffic flow detection logic submodule analyzes objects for two characteristics of a traffic flow pattern: acceleration and average non-zero velocity. These characteristics may reveal erratic occurrences in traffic flow proximate to the equipped vehicle during the driver's travel. To analyze for randomness during traffic flow scenarios, the traffic flow detection logic submodule performs multiple checks before determining traffic congestion.

A preliminary check analyzes periodic variation in acceleration values for each longitudinal velocity stored in the velocity buffers for the host lane and adjacent lanes. Due to the dynamic nature of traffic flow over a prolonged duration of time, the traffic flow detection logic submodule may use a threshold velocity value to determine sign changes for the acceleration, such that the sign changes identify acceleration and deceleration indicative of traffic congestion. The threshold velocity may be an average velocity of the equipped vehicle, an average velocity of the target object, an average velocity of an object other than the target object, a traffic speed limit of the road along which the equipped vehicle is traveling, a set-speed of the equipped vehicle's ACC feature, etc. For example, when the velocity of an object exceeds the threshold velocity, the traffic flow detection logic submodule determines that a positive acceleration has occurred. When the velocity of the object falls below the threshold velocity, the submodule may determine that a negative acceleration has occurred (i.e., deceleration).

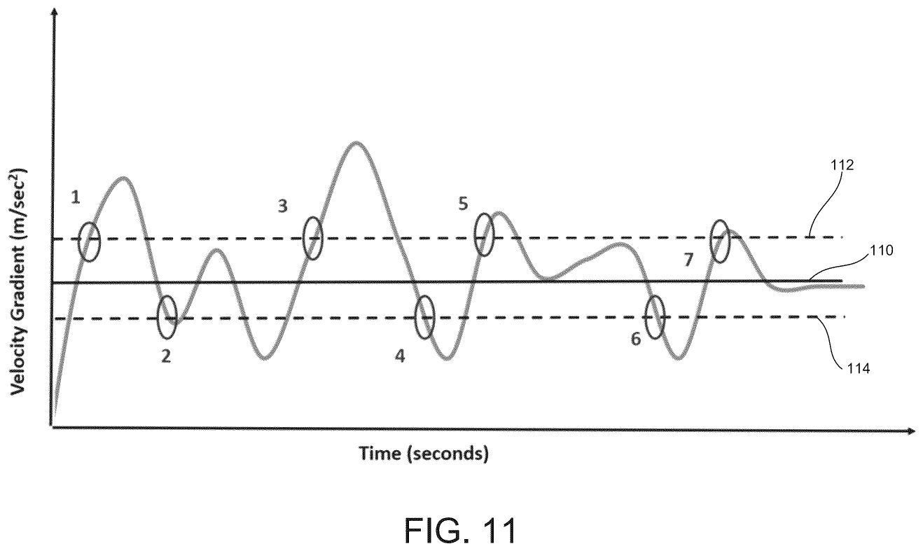

FIG. 11 illustrates a plot of an acceleration including the threshold velocity value 110, an upper limit threshold 112 on the positive acceleration, and a lower limit threshold 114 on the negative acceleration. The upper limit threshold 112 and the lower limit threshold 114 may represent percentages of the threshold velocity value 110 or an offset of the threshold velocity value 110. For example, the TCD module may determine the upper limit threshold 112 as 5%, 10%, 25%, or 50% greater than the threshold velocity value 110 (for example, a value within the range of 5% to 50%). Similarly, the TCD module may determine the lower limit threshold 114 as 5%, 10%, 25%, or 50% less than the threshold velocity value 110 (for example, a value within the range of 5% to 50%). Alternatively, the upper limit threshold 112 may be offset by a predetermined speed, such as 2 miles per hour (mph), 5 mph, 10 mph, 15 mph, or 20 mph greater than the threshold velocity value 110 (for example, a speed within the range of 2 mph to 20 mph), and the lower limit threshold 114 may be offset by a predetermined speed, such as 2 mph, 5 mph, 10 mph, 15 mph, or 20 mph less than the threshold velocity value 110 (for example, a speed within the range of 2 mph to 20 mph.

The larger the offset between the threshold velocity 110 and the limits 112, 114, the less sensitive the traffic congestion determination module will be to changes in acceleration of a target object, and therefore will be less likely to change output between a determination of high-density traffic determination and a low-density traffic determination. This may reduce abrupt changes or jerk in the ACC feature and/or other ADAS features using the traffic congestion determination. The smaller the offset between the threshold velocity 110 and the limits 112, 114, the more sensitive the traffic congestion determination module will be to changes in acceleration of a target object, and therefore will be more likely to change output between a determination of high-density traffic determination and a low-density traffic determination. This may increase changes in output of the ACC feature and/or other ADAS features using the traffic congestion determination, increasing the reaction time of the vehicle to the traffic conditions.

The percentages or offsets of the upper limit threshold 112 and the lower limit threshold 114 may be reciprocal of one another. For example, the upper limit threshold 112 is 10% greater than the threshold velocity value 110 and the lower limit threshold 114 is 10% less than the threshold velocity value 110. Alternatively, the percentages or offsets of the upper limit threshold 112 and the lower limit threshold 114 may be nonreciprocal of one another. For example, the upper limit threshold 112 is 10% greater than the threshold velocity value 110 and the lower limit threshold 114 is 5% of the threshold velocity value 110. Nonreciprocal limits 112, 114 may be used, for example, to make the traffic congestion determination more conservative in determining that high-density traffic has dissipated, or vice versa.

The limits 112, 114 may be static or dynamic. For example, the limits 112, 114 may be adjusted based on current conditions (e.g., a speed of the equipped vehicle, traffic density, weather conditions, ambient light levels, etc.). The upper limit threshold 112 and lower limit threshold 114 may prevent the traffic flow detection logic submodule from falsely identifying small changes in velocity as a sign change in the acceleration. Accordingly, the submodule may not identify a sign change in the acceleration until the velocity change exceeds the upper limit threshold 112 or falls below the lower limit threshold 114. Once the acceleration passes either threshold, the traffic flow detection logic submodule may identify a sign change in the acceleration.

The traffic flow detection logic submodule may also determine an average non-zero velocity for each velocity buffer at respective sample times. The submodule may determine whether the average non-zero velocity is a certain percentage “Y” below an upper threshold velocity value. Optionally, the upper threshold velocity value may be either the speed limit of the road along which the equipped vehicle is traveling or the set-speed of the ACC feature of the equipped vehicle.

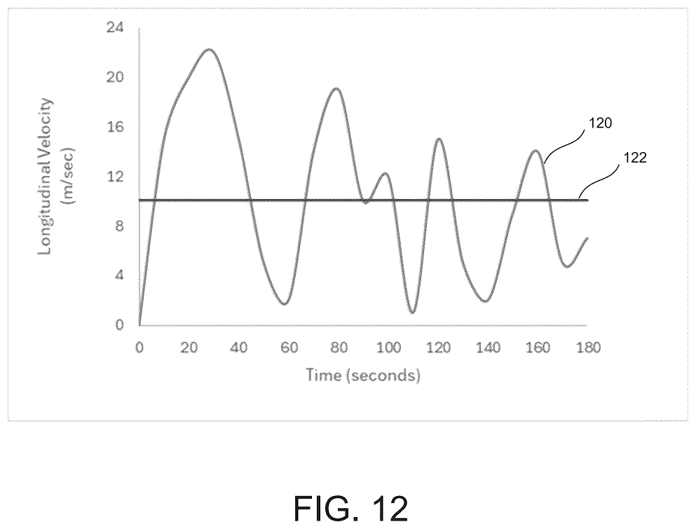

FIG. 12 illustrates an example plot of average non-zero velocity 120 of a velocity buffer where the equipped vehicle is traveling on a road having a 45 mph speed limit. The TCD module of the equipped vehicle has velocity buffers of length “n,” and the velocity buffers contain “n” velocity sample values recorded for a target object. When the average non-zero velocity 120 of the target object is lower than a threshold value 122, where the threshold value may be “Y” percentage of the speed limit (e.g., “Y” representing 50% of the 45 MPH speed limit, or approximately 22.5 MPH), the traffic flow detection logic submodule may determine that the equipped vehicle is in a high-density traffic flow. The threshold value 122 may be an average velocity of the equipped vehicle, an average velocity of the target object, an average velocity of an object other than the target object, a set-speed of the equipped vehicle's ACC feature, etc., or a percentage or offset of any of these values. For example, the TCD module may determine the threshold value 122 as 5%, 10%, 25%, 50%, etc. (for example, within the range of 5% to 50%) of a set-speed of the equipped vehicle's ACC feature. Alternatively, the TCD module may determine the threshold value 122 as an offset of a predetermined amount of speed, such as 2 mph, 5 mph, 10 mph, 15 mph, 20 mph, etc. (for example, a value within the range of 2 mph and 20 mph), of the traffic speed limit.

Through the acceleration determination and the average non-zero velocity check, the submodule precisely monitors the velocity buffers of the host lane and the adjacent lanes. The submodule may then determine the occurrence of a traffic congestion pattern (i.e., traffic information). The submodule outputs the traffic information to the decision-making module. The decision-making module may then provide outputs to ADAS features of the equipped vehicle. In one example, the decision-making module may output delayed acceleration/deceleration commands to the ACC to regulate longitudinal movements of the equipped vehicle. In another example, the decision-making module may output steering commands to the LCA to regulate lateral trajectory of the equipped vehicle or suggest a lane change to the driver of the equipped vehicle.

Thus, a TCD module is an ADAS feature that detects the pattern of traffic flow in the host lane of the equipped vehicle and the lanes adjacent to the host lane. The TCD module may include a down-sampling logic that determines a target object's velocity information corresponding to the lane in which the target object is traveling and stores the velocity information in a buffer according to the lane assignment. Optionally, a velocity buffer submodule stores velocity information received from the down-sampling logic for multiple target objects. In some examples, the velocity buffer submodule resets the buffer for a given lane when valid object velocity information pertaining to the lane is not available for a time equivalent to the buffer length duration. The TCD module may use an acceleration-based determination to detect drops and rises in the velocity profile of the target object. From the resulting acceleration, the TCD module may identify a traffic flow pattern. Optionally, the TCD module uses an average velocity-based determination to identify traffic flow behavior over a buffer period by comparing the resulting average non-zero velocity of a target object with either a traffic speed limit threshold or an ACC set-speed threshold. The TCD module may switch the respective lane buffers when the equipped vehicle performs a lane change to preserve target velocity history data of the lanes. The TCD module may integrate with other ADAS features, such as setting ACC controller gain changes based on traffic flow or communicating to the LCA a suggested lane change or a commanded auto-lane-change maneuver in the event of lane-specific traffic congestion.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. No. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor of the camera may capture image data for image processing and may comprise, for example, a two dimensional array of a plurality of photosensor elements arranged in at least 640 columns and 480 rows (at least a 640×480 imaging array, such as a megapixel imaging array or the like), with a lens focusing images onto the imaging array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or at least two million photosensor elements or pixels or at least three million photosensor elements or pixels or at least five million photosensor elements or pixels arranged in rows and columns. The imaging array may be sensitive to near-infrared light. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

The system may utilize sensors, such as radar sensors or imaging radar sensors or lidar sensors or the like, to detect presence of and/or range to objects and/or other vehicles and/or pedestrians. The sensing system may utilize aspects of the systems described in U.S. Pat. Nos. 10,866,306; 9,954,955; 9,869,762; 9,753,121; 9,689,967; 9,599,702; 9,575,160; 9,146,898; 9,036,026; 8,027,029; 8,013,780; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 7,053,357; 6,919,549; 6,906,793; 6,876,775; 6,710,770; 6,690,354; 6,678,039; 6,674,895 and/or 6,587,186, and/or U.S. Publication Nos. US-2019-0339382; US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

The radar sensors of the sensing system each comprise a plurality of transmitters that transmit radio signals via a plurality of antennas, a plurality of receivers that receive radio signals via the plurality of antennas, with the received radio signals being transmitted radio signals that are reflected from an object present in the field of sensing of the respective radar sensor. The system includes an ECU or control that includes a data processor for processing sensor data captured by the radar sensors. The ECU or sensing system may be part of a driving assist system of the vehicle, with the driving assist system controlling at least one function or feature of the vehicle (such as to provide autonomous driving control of the vehicle) responsive to processing of the data captured by the radar sensors.

The radar sensor or sensors may be disposed at the vehicle so as to sense exterior of the vehicle. For example, the radar sensor may comprise a front sensing radar sensor mounted at a grille or front bumper of the vehicle, such as for use with an automatic emergency braking system of the vehicle, an adaptive cruise control system of the vehicle, a collision avoidance system of the vehicle, etc., or the radar sensor may be comprise a corner radar sensor disposed at a front corner or rear corner of the vehicle, such as for use with a surround vision system of the vehicle, or the radar sensor may comprise a blind spot monitoring radars disposed at a rear fender of the vehicle for monitoring sideward / rearward of the vehicle for a blind spot monitoring and alert system of the vehicle. Optionally, the radar sensor or sensors may be disposed within the vehicle so as to sense interior of the vehicle, such as for use with a cabin monitoring system of the vehicle or a driver monitoring system of the vehicle or an occupant detection or monitoring system of the vehicle. The radar sensing system may comprise multiple input multiple output (MIMO) radar sensors having multiple transmitting antennas and multiple receiving antennas.

The ECU may be operable to process data for at least one driving assist system of the vehicle. For example, the ECU may be operable to process data (such as image data captured by a forward viewing camera of the vehicle that views forward of the vehicle through the windshield of the vehicle) for at least one selected from the group consisting of (i) a headlamp control system of the vehicle, (ii) a pedestrian detection system of the vehicle, (iii) a traffic sign recognition system of the vehicle, (iv) a collision avoidance system of the vehicle, (v) an emergency braking system of the vehicle, (vi) a lane departure warning system of the vehicle, (vii) a lane keep assist system of the vehicle, (viii) a blind spot monitoring system of the vehicle and (ix) an adaptive cruise control system of the vehicle. Optionally, the ECU may also or otherwise process radar data captured by a radar sensor of the vehicle or other data captured by other sensors of the vehicle (such as other cameras or radar sensors or such as one or more lidar sensors of the vehicle). Optionally, the ECU may process captured data for an autonomous control system of the vehicle that controls steering and/or braking and/or accelerating of the vehicle as the vehicle travels along the road.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular driving assist system, the vehicular driving assist system comprising:
a sensor disposed at a vehicle equipped with the vehicular driving assist system, wherein the sensor senses at least forward of the equipped vehicle, and wherein the sensor is operable to capture sensor data;
an electronic control unit (ECU) comprising electronic circuitry and associated software;
wherein sensor data captured by the sensor is transferred to the ECU;
wherein the electronic circuitry of the ECU comprises a data processor, and wherein the data processor is operable to process sensor data captured by the sensor and transferred to the ECU;
wherein the vehicular driving assist system, while the equipped vehicle travels along a traffic lane of a road, and via processing at the ECU of captured sensor data, determines a leading vehicle ahead of the equipped vehicle and traveling in the same traffic lane as the equipped vehicle;
wherein the vehicular driving assist system, at least in part via processing at the ECU of captured sensor data, determines a plurality of velocity measurements of the determined leading vehicle;
wherein the vehicular driving assist system, based on the plurality of velocity measurements, (i) determines an acceleration pattern of the determined leading vehicle and (ii) determines an average forward velocity of the determined leading vehicle; and
wherein the vehicular driving assist system, responsive to determining the acceleration pattern of the determined leading vehicle and the average forward velocity of the determined leading vehicle, determines a traffic flow condition of the traffic lane ahead of the equipped vehicle.

2. The vehicular driving assist system of claim 1, wherein the vehicular driving assist system, responsive to determining the traffic flow condition of the traffic lane ahead of the equipped vehicle, at least in part controls at least one selected from the group consisting of (i) acceleration of the equipped vehicle and (ii) steering of the equipped vehicle.

3. The vehicular driving assist system of claim 1, wherein the vehicular driving assist system determines a second vehicle ahead of the equipped vehicle and traveling along an adjacent traffic lane to the traffic lane the equipped vehicle is traveling along, and wherein the vehicular driving assist system determines an acceleration pattern and an average forward velocity of the determined second vehicle, and wherein the vehicular driving assist system, based on the acceleration pattern and the average forward velocity of the determined second vehicle, determines a traffic flow condition of the adjacent traffic lane.

4. The vehicular driving assist system of claim 3, wherein the vehicular driving assist system, responsive to determining the traffic flow condition of the traffic lane ahead of the equipped vehicle and responsive to determining the traffic flow condition of the adjacent traffic lane, at least in part controls the at least one selected from the group consisting of (i) acceleration of the equipped vehicle and (ii) steering of the equipped vehicle.

5. The vehicular driving assist system of claim 3, wherein the vehicular driving assist system controls steering of the equipped vehicle to maneuver the equipped vehicle into the adjacent traffic lane.

6. The vehicular driving assist system of claim 1, wherein the vehicular driving assist system, responsive to determining the traffic flow condition of the traffic lane ahead of the equipped vehicle, provides instructions to a driver of the equipped vehicle to make a lane change.

7. The vehicular driving assist system of claim 1, wherein the vehicular driving assist system determines the traffic flow condition of the traffic lane ahead of the equipped vehicle based at least in part on the average forward velocity of the determined leading vehicle relative to a threshold speed.

8. The vehicular driving assist system of claim 7, wherein the threshold speed is based on one selected from the group consisting of (i) a traffic speed limit associated with the traffic lane the equipped vehicle is traveling along and (ii) a set-speed of a cruise control system of the equipped vehicle.

9. The vehicular driving assist system of claim 1, wherein the vehicular driving assist system determines the acceleration pattern of the determined leading vehicle based on determining whether each velocity measurement of the plurality of velocity measurements is greater than an upper limit threshold value or is lesser than a lower limit threshold value.

10. The vehicular driving assist system of claim 1, wherein the vehicular driving assist system controls acceleration of the equipped vehicle to decelerate the equipped vehicle based at least in part on the determined traffic flow condition.

11. The vehicular driving assist system of claim 1, wherein the vehicular driving assist system stores the plurality of velocity measurements of the determined leading vehicle in a host lane buffer.

12. The vehicular driving assist system of claim 11, wherein the vehicular driving assist system stores a plurality of velocity measurements of a second vehicle ahead of the equipped vehicle and traveling along an adjacent traffic lane that is adjacent to the traffic lane the equipped vehicle is traveling along in an adjacent lane buffer.

13. The vehicular driving assist system of claim 12, wherein the vehicular driving assist system, responsive to the equipped vehicle performing a lane change to the adjacent traffic lane, reassigns the adjacent lane buffer and the host lane buffer to reflect the lane change.

14. The vehicular driving assist system of claim 1, further comprising a plurality of sensors, and wherein the plurality of sensors comprises a camera and a radar sensor.

15. A vehicular driving assist system, the vehicular driving assist system comprising:
a radar sensor disposed at a vehicle equipped with the vehicular driving assist system, wherein the radar sensor senses at least forward of the equipped vehicle, and wherein the radar sensor is operable to capture sensor data;
an electronic control unit (ECU) comprising electronic circuitry and associated software;
wherein sensor data captured by the radar sensor is transferred to the ECU;
wherein the electronic circuitry of the ECU comprises a data processor, and wherein the data processor is operable to process sensor data captured by the radar sensor and transferred to the ECU;
wherein the vehicular driving assist system, while the equipped vehicle travels along a traffic lane of a road, and via processing at the ECU of captured sensor data, determines a first leading vehicle ahead of the equipped vehicle and traveling in the same traffic lane as the equipped vehicle;
wherein the vehicular driving assist system determines a second vehicle ahead of the equipped vehicle and traveling along an adjacent traffic lane to the traffic lane that the equipped vehicle is traveling along;
wherein the vehicular driving assist system, at least in part via processing at the ECU of captured sensor data, determines a plurality of velocity measurements of (i) the determined first leading vehicle and (ii) the determined second vehicle;
wherein the vehicular driving assist system (i) stores the plurality of velocity measurements of the determined first leading vehicle in a host lane buffer and (ii) stores the plurality of velocity measurements of the determined second vehicle traveling in an adjacent lane buffer;
wherein the vehicular driving assist system, based on the plurality of velocity measurements, (i) determines an acceleration pattern of the determined first leading vehicle and (ii) determines an average forward velocity of the determined first leading vehicle;
wherein the vehicular driving assist system, based on the plurality of velocity measurements, (i) determines an acceleration pattern of the determined second vehicle and (ii) determines an average forward velocity of the determined second vehicle;
wherein the vehicular driving assist system, responsive to determining the acceleration pattern of the determined first leading vehicle and the average forward velocity of the determined first leading vehicle, determines a traffic flow condition of the traffic lane ahead of the equipped vehicle; and
wherein the vehicular driving assist system, based on the acceleration pattern of the determined second vehicle and the average forward velocity of the determined second vehicle, determines a traffic flow condition of the adjacent traffic lane.

16. The vehicular driving assist system of claim 15, wherein the vehicular driving assist system, responsive to (i) determining the traffic flow condition of the traffic lane ahead of the equipped vehicle and (ii) determining the traffic flow condition of the adjacent traffic lane, provides instructions to a driver of the equipped vehicle to make a lane change to the adjacent traffic lane.

17. The vehicular driving assist system of claim 16, wherein the vehicular driving assist system, responsive to the equipped vehicle performing the lane change to the adjacent traffic lane, reassigns the adjacent lane buffer and the host lane buffer to reflect the lane change.

18. A vehicular driving assist system, the vehicular driving assist system comprising:
a camera disposed at a vehicle equipped with the vehicular driving assist system, wherein the camera views at least forward of the equipped vehicle, and wherein the camera is operable to capture image data;
an electronic control unit (ECU) comprising electronic circuitry and associated software;
wherein image data captured by the camera is transferred to the ECU;
wherein the electronic circuitry of the ECU comprises a data processor, and wherein the data processor is operable to process image data captured by the camera and transferred to the ECU;
wherein the vehicular driving assist system, while the equipped vehicle travels along a traffic lane of a road, and via processing at the ECU of captured image data, determines a leading vehicle ahead of the equipped vehicle and traveling in the same traffic lane as the equipped vehicle;
wherein the vehicular driving assist system determines a plurality of velocity measurements of the determined leading vehicle;
wherein the vehicular driving assist system, based on the plurality of velocity measurements, determines an average forward velocity of the determined leading vehicle;
wherein the vehicular driving assist system determines an acceleration pattern of the determined leading vehicle based on determining whether each velocity measurement of the plurality of velocity measurements is greater than an upper limit threshold value or is lesser than a lower limit threshold value, and wherein the upper limit threshold value and the lower limit threshold value are based on one selected from the group consisting of (i) a traffic speed limit associated with the traffic lane ahead of the equipped vehicle and (ii) a set-speed of a cruise control system of the equipped vehicle; and
wherein the vehicular driving assist system, responsive to determining the acceleration pattern of the determined leading vehicle and the average forward velocity of the determined leading vehicle, determines a traffic flow condition of the traffic lane ahead of the equipped vehicle.

19. The vehicular driving assist system of claim 18, wherein the vehicular driving assist system, responsive to determining the traffic flow condition of the traffic lane ahead of the equipped vehicle, at least in part controls at least one selected from the group consisting of (i) acceleration of the equipped vehicle and (ii) steering of the equipped vehicle.

20. The vehicular driving assist system of claim 18, wherein the vehicular driving assist system determines a second vehicle traveling along an adjacent traffic lane to the traffic lane ahead of the equipped vehicle, and wherein the vehicular driving assist system determines an acceleration pattern and an average forward velocity of the determined second vehicle, and wherein the vehicular driving assist system, based on the acceleration pattern and the average forward velocity of the determined second vehicle, determines a traffic flow condition of the adjacent traffic lane.
